(19) United States
(12) Patent Application Publication
(10) Pub. No.: US 2015/0047739 A1
(43) Pub. Date: Feb. 19, 2015

(54) METHOD FOR DETERMINING START CONDITIONS WHEN REFUELING A GAS TANK

(71) Applicants: Morten Wistoft-Ibsen, Herning (DK); Leif Kappel Petersen, Lem St (DK); Peter Bodker, Herning (DK)

(72) Inventors: Morten Wistoft-Ibsen, Herning (DK); Leif Kappel Petersen, Lem St (DK); Peter Bodker, Herning (DK)

(73) Assignee: H2 Logic A/S, Herning (DK)

(21) Appl. No.: 14/383,948

(22) PCT Filed: Mar. 9, 2012
(86) PCT No.: PCT/DK2012/050073

§ 371 Date: Sep. 9, 2014

(51) Int. Cl. F17C 5/00; F17C 13/02; F17C 5/06

(52) U.S. Cl. CPC F17C 5/007; F17C 5/06; F17C 13/025
USPC 141/4; 141/39; 141/21; 141/95

(57) ABSTRACT

A method is disclosed for determining the start pressure within a gas tank (4) to be refueled, said method comprising the steps of connecting the gas tank (4) to a dispenser volume (3) of a dispenser unit (3, 5-7, 10, 11), which volume (3) is significantly smaller than the volume of the gas tank (4) to be refueled, applying a pressure to the gas in the dispenser volume (3), which pressure is equal to or higher than the pressure within the gas tank (4), so that gas start to flow from the dispenser volume (3) into the gas tank (4) through a check valve (9), which is a part of the gas tank (4), and determining the start pressure by measuring the pressure at the interface (8) between the dispenser unit (3, 5-7, 10, 11) and the gas tank (4).

### FIELD OF THE INVENTION

The present invention relates to a method for determining relevant start conditions, particularly relating to the tank pressure, when refueling a gas tank.

### BACKGROUND OF THE INVENTION

When refueling gas tanks, especially hydrogen tanks, it is important not to compromise the tank limits, particularly the pressure and the temperature of the gas within the tank. As both of these parameters increase when gas is filled into the tank, these considerations limit the rate by which the tank may be filled. On the other hand, the increase of pressure should be optimized in order to minimize the time needed for refueling the gas tank.

An important precondition for being able to make such an optimization and control the refueling process in a safe manner is to know the start conditions before beginning the refueling. A parameter of particular interest in this matter is the start pressure of the gas in the gas tank.

A well-known method of determining this start pressure involves the use of a pressure pulse. This method is based on pressure equalization between the gas in a dispensing unit and the gas in the gas tank. Thus, when the gas pressure in the refueling nozzle of the dispensing unit equals the gas pressure in the gas tank, the start pressure is defined.

However, this method is not without problems, as gas will inevitably enter the gas tank during the application of such a pressure pulse. This means that the gas pressure and thereby also the temperature in the gas tank increases, and the start conditions are changed.

### BRIEF DESCRIPTION OF THE INVENTION

It is an object of the present invention to provide a method for determining the start conditions, especially the start pressure, of a gas tank by means of pressure pulse with only a minimal impact on these start conditions.

The present invention relates to a method for determining the start pressure within a gas tank to be refueled, said method comprising the steps of connecting the gas tank to a dispenser volume of a dispenser unit, which volume is significantly smaller than the volume of the gas tank to be refueled, applying a pressure to the gas in the dispenser volume, which pressure is equal to or higher than the pressure within the gas tank, so that gas start to flow from the dispenser volume into the gas tank through a check valve, which is a part of the gas tank, and determining the start pressure by measuring the pressure at the interface between the dispenser unit and the gas tank.

In this context, the expression “dispenser volume” is to be understood as a part of the gas dispensing system of the dispenser unit, in which the pressure is controlled very accurately when determining the start pressure within the gas tank and when refueling the gas tank. Typically, this dispenser volume will consist of the outermost part of the gas dispensing system, more specifically the part of the gas dispensing system, which is positioned downstream a pressure regulating device used for controlling the pressure within the dispenser volume. In some embodiments, the dispenser volume or part thereof may be constituted by a gas conduit leading from the pressure regulating device and possibly through a heat exchanger towards the interface between the dispenser unit and the gas tank.

This method has proven to lead to a safe and reliable determination of the start pressure causing only a minimal change of this start pressure due to gas flowing into the gas tank during the determination thereof.

In an embodiment of the invention, the dispenser volume is chosen so that volume of the gas tank to be refueled is at least five times as large, preferably at least 25 times as large, most preferably at least 100 times as large, as the dispenser volume.

Relative volume differences of these sizes have proven to be advantageous for obtaining optimum results of the determination.

In an embodiment of the invention, the dispenser volume is less than 0.004 m³, preferably less than 0.001 m³.

Such dispenser volumes are optimized for use with most common gas tanks of vehicles powered by hydrogen.

In an embodiment of the invention, the step of applying a pressure to the gas in the dispenser volume involves the application of a pressure pulse of short duration obtaining a maximum pressure corresponding at least to the pressure to which the gas tank is rated, and the step of determining the start pressure is performed at the point of time, where gas starts to flow into the gas tank.

This is one of the simplest ways to make sure that pressure equalization between the dispenser volume and the gas tank is obtained.

In a further embodiment of the invention, the method further comprises the step of closing a valve between the dispenser volume and the gas tank as soon as gas starts to flow into the gas tank, so that the amount of gas flowing into the gas tank is kept at a minimum.

In this way, it is assured that the flow of gas into the gas tank is stopped as soon as the pressure equalization has been obtained, and the pressure increase in the gas tank is minimized.

In an embodiment of the invention, the method comprises the additional steps of closing a valve between the dispenser volume and the gas tank before applying the pressure to the gas in the dispenser volume, opening the valve after having applied a pressure to the dispenser volume and either closing the valve again as soon as gas starts to flow into the gas tank and continuing to the step of determining the start pressure or closing the valve and repeating the above these additional steps with a higher pressure, if pressure equalization is not obtained and the gas does not start flowing into the gas tank.

This embodiment represents another way of obtaining pressure equalization between the dispenser volume and the gas tank.

In a further embodiment of the invention, the first pressure applied to the gas in the dispenser volume corresponds at least to the pressure to which the gas tank is rated.

Using the rated tank pressure as the pressure applied to the dispenser volume significantly increases the chance of obtaining pressure equalization between the dispenser volume and the gas tank at the first attempt.

In a further embodiment of the invention, the valve is opened very slowly.

By opening the valve very slowly, the flow of gas into the gas tank is limited.

In another further embodiment of the invention, a narrow orifice is arranged in series with the valve.

Using a narrow orifice is another way of limiting the flow of gas into the gas tank.

In an embodiment of the invention, the step of applying a pressure to the gas in the dispenser volume involves increasing the pressure slowly until gas starts flowing into the gas tank.

By increasing the pressure up to the point of pressure equalization, the pressure differences between the dispenser volume and the gas tank, and thereby also the flow of gas into the gas tank, are minimized.

In a further embodiment of the invention, the pressure is increased continuously.

In another further embodiment of the invention, the pressure is increased stepwise, preferably in steps of less than 60 MPa, for instance in steps of between 5 MPa and 15 MPa.

In a further embodiment of the invention, the step of applying a pressure to the gas in the dispenser volume further involves the application of an initial pressure to the gas in the dispenser volume corresponding to a tank pressure communicated from the vehicle, possibly with a minor positive offset, before starting to increase the pressure.

The application of an initial pressure to the gas in the dispenser volume corresponding to a tank pressure communicated from the vehicle, possibly with a minor positive offset, before starting to increase the pressure may reduce the time used for determining the start pressure within the gas tank significantly, as a smaller increase of the pressure is needed to obtain pressure equalization.

In another further embodiment of the invention, the method comprises, before starting to increase the pressure, the additional steps of closing a valve between the dispenser volume and the gas tank, applying a pressure to the gas in the dispenser volume, opening the valve and, if pressure equalization is not obtained, optionally repeating these additional steps one or more times with, each time with a higher pressure applied to the gas in the dispenser volume, wherein the pressure(s) applied to the gas in the dispenser volume is/are between zero and the pressure to which the gas tank is rated, the first of the pressures applied preferably being of 15-20 MPa.

The application of one or more pressures before starting the general increase of the pressure may reduce the time used for determining the start pressure within the gas tank significantly, as a smaller increase of the pressure is needed to obtain pressure equalization.

In an embodiment of the application, if pressure equalization is not obtained, instead of repeating the additional steps mentioned above, a pressure corresponding to a tank pressure communicated from the vehicle, possibly with a minor positive offset, is applied to the gas in the dispenser volume before starting to increase the pressure.

Applying a pressure corresponding to a tank pressure communicated from the vehicle, possibly with a minor positive offset, to the gas in the dispenser volume substantially increases the possibility of obtaining pressure equalization at the first attempt.

### FIGURES

A few exemplary embodiments of the invention will be described in the following with reference to the figures, wherein

FIG. 1 illustrates schematically a pressure-time curve for a pressure pulse and a following refueling of a gas tank,

FIG. 2 illustrates schematically the necessary set-up for performing a method according to a first embodiment of the invention and

FIG. 3 illustrates schematically the necessary set-up for performing a method according to a second embodiment of the invention.

### DETAILED DESCRIPTION OF THE INVENTION

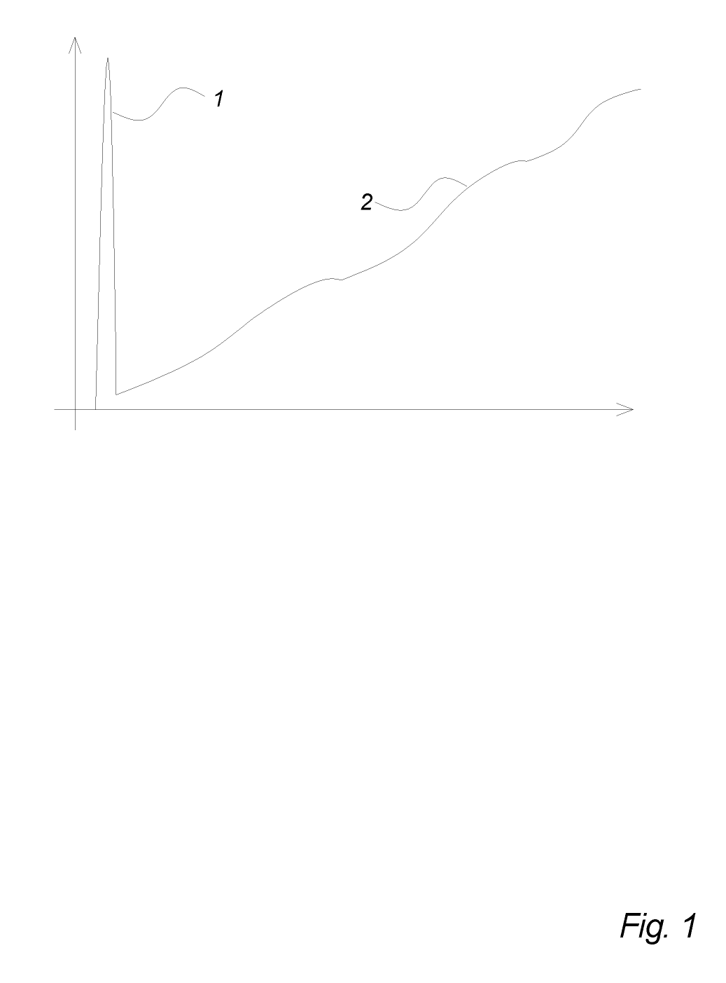

The basic principle behind the present invention is illustrated schematically in FIG. 1, which shows schematically a pressure-time curve for the pressure within a dispenser volume 3 connected to a gas tank 4 to be refueled. In order to determine the start pressure within the gas tank 4, a pressure pulse 1 may be applied to the gas in the dispenser volume 3.

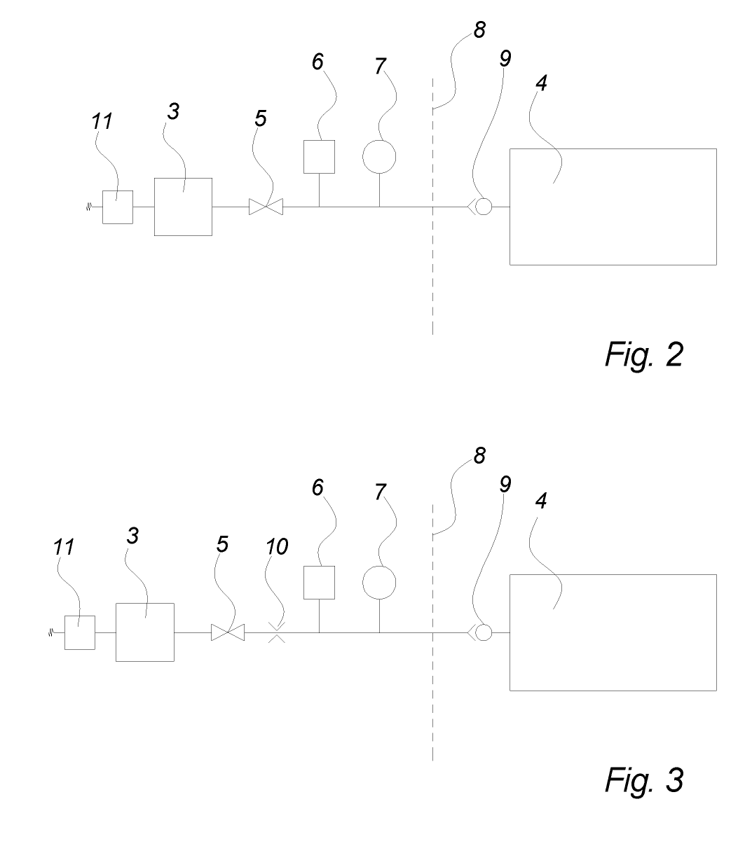

If the dispenser volume 3 placed downstream a pressure regulating device 11 is connected to the gas tank 4 through an open valve 5 and a check valve 9 ensuring that gas does not flow out of the gas tank 4 as schematically illustrated in FIG. 2, the application of the pressure pulse 1 in the dispenser volume 3 will force the check valve 9 to be opened for a short time. As long as the pressure in the dispenser volume 3 is larger than the start pressure in the gas tank 4, gas will flow from the dispenser volume 3 into the gas tank 4. A flow meter 6 may be used for detecting the times at which the check valve 9 opens and closes, respectively. At these two points of time, the pressure at the interface 8 between the dispenser unit and the gas tank 4 equals the pressure within the gas tank 4. Thus, the start pressure in the gas tank 4 may be determined at these two points of time by means of a pressure meter 7 placed near that interface 8.

When the start pressure has been determined, the refueling can begin, which is indicated by the raising pressure curve 2 in FIG. 1. The average rate at which the pressure should be increased and the fueling target pressure to be reached depend on the start pressure in the gas tank 4, on the ambient temperature and on the type of refueling station used for the refueling.

As mentioned above, this method cannot be used without taking into consideration that the entrance of gas into the gas tank 4 during the application of the pressure pulse 1 results in an increased pressure and an increased temperature within the gas tank 4. In other words, the procedure used for determining the start conditions also changes these start conditions.

In order to minimize the effects of the application of a pressure pulse 1 on the start conditions to be determined and to ensure that the refueling is performed in a safe manner, a maximum allowable increase of the pressure in the gas tank 4 of 2.0 MPa during the application of the pressure pulse 1 has been suggested. For small gas tanks 4, however, only a small volume of gas has to be transferred to the gas tank 4 during the application of the pressure pulse 1 for this limit to be exceeded. This is especially a problem, if the volume 3 of the dispenser unit is large compared to the volume of the gas tank 4, which is often the case, since the volume 3 of the dispenser unit is defined by other limitations not taking into account the problematic related to the use of pressure pulses 1.

The present invention provides a solution to this problem by assuring that the dispenser volume 3 is small compared to the volume of the gas tank 4. Preferably, the dispenser volume 3 is chosen so that the volume of the gas tank 4 is at least 5-10 times larger than the dispenser volume. Whereas, for instance, known volumes of gas tanks 4 typically are found in the range between approximately 0.025 m³ and 0.42 m³, the volume of the gas container 3 may be less than 0.004 m³ or even less than 0.001 m³. In principle, the volume can go all the way down to 0, if the small gas container 3 is represented by a small piece of tube, which is pressurized during the application of the pressure pulse 1.

Because the dispenser volume 3 is much smaller than the volume of the gas tank 4, only a minimal amount of gas flows to the gas tank 4 during the application of the pressure pulse 1.

In general, two types of gas tanks 4 are used in vehicles powered by hydrogen. The first type is rated to a pressure of 70 MPa when it is full, and the refueling start pressure may be anywhere between 2 MPa and 70 MPa depending on the amount of gas in the gas tank 4 at the time of refueling. The other type is rated to a full tank pressure of 35 MPa, and the refueling start pressure may be in the range from 2 MPa to 35 MPa.

Thus, in order to be sure that the maximum pressure of the pressure pulse 1 exceeds the start pressure of the gas tank 4, the amplitude of the pressure pulse must exceed 70 MPa, respectively 35 MPa, depending on the type of the tank to be refueled.

Apart from applying the pressure pulse 1 in a well-controlled manner, raising the pressure either continuously or stepwise, several other approaches than the relatively simple application of a pressure pulse 1 as described above may be taken to determine the start pressure of a gas tank 4 to be refueled.

One way is to stop the pressure increase at the interface 8 between the dispenser unit and the gas tank 4 as soon as the flow meter 6 indicates that gas starts to flow through the check valve 9, i.e. when the pressures in the dispenser volume 3 and in the gas tank 4 are equalized. This can be done by closing the valve 5 as soon as the flow meter 6 indicates that there is a flow through the valve 6. After that, the pressure at the interface 8, which can be measured by means of the pressure meter 7, will equal the start pressure in the gas tank 4.

Another method of determining the start pressure within the gas tank 4 is to close the valve 5 and apply a pressure to the dispenser volume 3 corresponding to the maximum pressure of the pressure pulse 1. If the valve 5 is opened very slowly until the flow meter 6 indicates that gas starts flowing through the check valve 9 into the gas tank 4, the valve 5 may be closed again and the start pressure may be measured by the pressure meter 7, because the pressure at the interface 8 is the same as the pressure in the gas tank 4, when the check valve 9 has been opened. In this way, it is assured that the flow of gas into the gas tank 4 is limited to an absolute minimum.

In a similar method a narrow orifice 10 arranged in series with the valve 5 as illustrated schematically in FIG. 3 may be used instead of a slowly opening valve 5. When the valve is opened and the equalization of pressures is obtained, the narrow orifice 10 will limit the flow of gas into the gas tank 4, thereby limiting the increase of the pressure therein during the determination of the start pressure.

Yet another method of determining the start pressure within the gas tank 4 may be used to minimize the pressure differences between the gas in the dispenser volume 3 and the gas in the gas tank 4 at the time of pressure equalization. In this method, a relatively low initial pressure of, for instance, 15-20 MPa is applied to the gas in the dispenser volume 3, and the valve 5 is opened. If equalization between the pressures in the dispenser volume 3 and the gas tank 4 is obtained, the valve 5 is closed as described above and the start pressure has been determined. If not, the valve 5 is left open and the pressure in the dispenser volume 3 is increased in relatively small steps of, for instance, 5-15 MPa until pressure equalization is detected by the flow meter 6, at which time the valve 5 is closed and the start pressure can be determined by means of the flow meter 7 as described above.

In variations of this latter method, the application of the initial pressure may be omitted so that the small step increases of the pressures begins from a very low value, such as 5 MPa, or the pressure may be increased continuously instead of stepwise (with or without application of the initial pressure).

Furthermore, this method may be improved if the refueling station and the vehicle are able to communicate with each other. If so, the initial pressure may be chosen to correspond to a tank pressure communicated from the vehicle (perhaps with a small positive offset), whereby the chance of obtaining pressure equalization at the first attempt, thereby decreasing the time needed for the determination of the start pressure, may be significantly increased.

It should be noted that the present invention is not restricted in any way by the descriptions above, which represent a few exemplary and illustrative embodiments only, whereas the scope of the present invention is defined by the following claims.

### LIST OF REFERENCE NUMBERS

1. Pressure pulse
2. Increasing pressure during refueling
3. Dispenser volume connected to gas tank
4. Gas tank
5. Valve
6. Flow meter
7. Pressure meter
8. Interface between dispenser and gas tank
9. Check valve
10. Narrow orifice
11. Pressure regulating device

1. A method for determining a start pressure within a gas tank to be refueled, said method comprising the steps of:
connecting the gas tank to a dispenser volume of a dispenser unit, which volume is significantly smaller than a volume of the gas tank to be refueled,
applying a pressure to gas in the dispenser volume, which pressure is equal to or higher than a pressure within the gas tank, so that gas start to flow from the dispenser volume into the gas tank through a check valve, which is a part of the gas tank, and
determining the start pressure by measuring a pressure at an interface between the dispenser unit and the gas tank.

2. The method according to claim 1, wherein the dispenser volume is chosen so that volume of the gas tank to be refueled is at least five times as large as the dispenser volume.

3. The method according to claim 1, wherein the dispenser volume is less than 0.004 m³.

4. The method according to claim 1, wherein the step of applying a pressure to the gas in the dispenser volume involves increasing the pressure slowly until gas starts flowing into the gas tank.

5. The method according to claim 4, further comprising, before starting to increase the pressure, the additional steps of:
closing a valve between the dispenser volume and the gas tank,
applying a pressure to the gas in the dispenser volume,
opening the valve, and
when pressure equalization is not obtained, repeating these additional steps one or more times, each time with a higher pressure applied to the gas in the dispenser volume,
wherein the pressure(s) applied to the gas in the dispenser volume is/are between zero and the pressure to which the gas tank is rated, the first of the pressures applied preferably being of 15-20 MPa.

6. The method according to claim 4, further comprising, before starting to increase the pressure, the additional steps of:
closing a valve between the dispenser volume and the gas tank,
applying a pressure to the gas in the dispenser volume, the pressure corresponding to a tank pressure communicated from a vehicle comprising said gas tank, possibly with a minor offset, and
opening the valve.

7. The method according to claim 4, wherein the step of applying a pressure to the gas in the dispenser volume further involves the application of an initial pressure to the gas in the dispenser volume corresponding to a tank pressure communicated from a vehicle comprising said gas tank, possibly with a minor positive offset, before starting to increase the pressure.

8. The method according to claim 4, wherein the pressure is increased continuously.

9. The method according to claim 4, wherein the pressure is increased stepwise, preferably in steps of less than 60 MPa.

10. The method according to claim 1, further comprising the additional steps of:
closing a valve between the dispenser volume and the gas tank before applying the pressure to the gas in the dispenser volume,
opening the valve after having applied a pressure to the gas in the dispenser volume, and
closing the valve again when gas starts to flow into the gas tank and continuing to the step of determining the start pressure, or
closing the valve and repeating these additional steps with a higher pressure when pressure equalization is not obtained and the gas does not start flowing into the gas tank.

11. The method according to claim 10, wherein the first pressure applied to the gas in the dispenser volume corresponds at least to the pressure to which the gas tank is rated.

12. The method according to claim 10, wherein the valve is opened very slowly.

13. The method according to claim 10, wherein a narrow orifice is arranged in series with the valve.

14. The method according to claim 1, wherein
the step of applying a pressure to the gas in the dispenser volume involves the application of a pressure pulse of short duration obtaining a maximum pressure corresponding at least to the pressure to which the gas tank is rated, and
the step of determining the start pressure is performed at the point of time, where gas starts to flow into the gas tank.

15. The method according to claim 14, further comprising the step of:
closing a valve between the dispenser volume and the gas tank as soon as gas starts to flow into the gas tank, so that the amount of gas flowing into the gas tank is kept at a minimum.

16. The method according to claim 1, wherein the dispenser volume is chosen so that volume of the gas tank to be refueled is at least 25 times as large as the dispenser volume.

17. The method according to claim 1, wherein the dispenser volume is chosen so that volume of the gas tank to be refueled is at least 100 times as large as the dispenser volume.

18. The method according to claim 1, wherein the dispenser volume is less than 0.001 m³.

19. The method according to claim 4, wherein the pressure is increased stepwise, preferably in steps of between 5 MPa and 15 MPa.

20. Gas dispenser unit arranged to determine a start pressure of a gas tank to be refueled, the gas dispenser unit comprising
a dispenser volume significantly smaller than a volume of the gas tank to be refueled;
a pressure regulating device arranged to apply pressure to gas in the dispenser volume; and
a pressure meter arranged to measure a pressure between the valve and the gas tank to be refueled;
wherein the dispenser unit is arranged to by means of the pressure regulating device apply a pressure to gas in the dispenser volume until the pressure is sufficient to open a check valve of the gas tank to be refueled; and wherein the dispenser unit is arranged to determine the start pressure of the gas tank to be refueled by means of the pressure meter.
